(19) United States
(12) Patent Application Publication
(10) Pub. No.: US 2020/0156155 A1
(43) Pub. Date: May 21, 2020

(54) METHOD FOR CONNECTING COMPONENTS BY MEANS OF A METAL PASTE

(71) Applicants: Heraeus Deutschland GmbH & Co. KG, Hanau (DE); Heraeus Nobleligh GmbH, Hanau (DE)

(72) Inventors: Wolfgang Schmitt, Rodgau (DE); Michael Schäfer, Künzell (DE); Susanne Klaudia Duch, Bruchköbel (DE); Ly May Chew, Bruchköbel (DE); Jens Nachreiner, Schlüchtern (DE); Dieter Zech, Kleinostheim (DE); Jörg Wöll, Ortenberg (DE); Jürgen Weber, Kleinostheim (DE)

(21) Appl. No.: 16/604,124

(22) PCT Filed: Feb. 7, 2018
(86) PCT No.: PCT/EP2018/053054

§ 371 Date: Oct. 9, 2019

(30) Foreign Application Priority Data
May 12, 2017 (EP) 17170738.3

(51) Int. Cl. B22F 7/06; B23K 35/02; B22F 1/00; B22F 3/14

(52) U.S. Cl. CPC B22F 7/064; B23K 35/025; B22F 2202/11; B22F 3/14; B22F 1/0074

(57) ABSTRACT

The invention relates to a method for connecting components, comprising the following steps: (I) applying a metal paste containing an organic solvent to the contact surface of a first component; (2) optionally applying the metal paste to the contact surface of a second component to be connected to the first component; (3) drying the metal paste applied to the contact surface of the first and optionally also to the contact surface of the second component; (4) producing a sandwich arrangement with the two components and the dried metal paste in-between; and (5) pressure sintering the sandwich arrangement comprising the layer of dried metal paste. The invention is characterised in that the drying is performed by irradiating with IR radiation with a peak wavelength in the wavelength range of between 750 and 1500 nm.

The invention relates to a method for connecting components by means of a metal paste.

In the field of power and consumer electronics, the connecting of components, which have a high pressure and temperature sensitivity, represents a particular challenge. This is why such pressure- and temperature-sensitive components are often connected to one another by means of adhesion. The adhesion technique has the disadvantage, however, that contact points between the components, which have an only insufficient heat conductivity or electrical conductivity, respectively, are created thereby.

A known solution of this problem is to connect components to be connected by means of pressure sintering. Pressure sintering represents a very simple method for connecting components in a stable manner. A metal paste containing an organic solvent is thereby usually applied to the contact surface to be connected, of one of the or of both of the components to be connected, and is initially dried, usually in a circulating air oven. The drying process thereby requires a time period of usually in the range of between 10 and 30 minutes at oven temperatures in the range of between 80 and 150° C. Facing one another, the contact surfaces to be connected are subsequently brought into contact with one another by means of the dried metal paste in-between by forming a sandwich arrangement. A pressure sintering step follows, which is performed at increased temperature, in the course of which the fixed mechanical connection between the components is created. The pressure sintering can take place, for example, by using a heated sintering press, in an oven having a pressing device, for example in the form of a die, or in an overpressure oven.

It has become evident that the drying period prior to the actual pressure sintering can be significantly shortened by means of the method according to the invention disclosed below.

The method according to the invention is a method for connecting components, comprising the following steps:

(1) applying a metal paste containing an organic solvent to the contact surface of a first component,

(2) optionally applying the metal paste to the contact surface of a second component to be connected to the first component,

(3) drying the metal paste applied to the contact surface of the first and optionally also to the contact surface of the second component,

(4) producing a sandwich arrangement with the two components and the dried metal paste in-between, and

(5) pressure sintering the sandwich arrangement comprising the layer of dried metal paste,

characterized in that the drying is performed by irradiation with IR radiation (infrared radiation) with a peak wavelength in the wavelength range of between 750 and 1500 nm.

The method according to the invention comprises the steps (1) to (5). They are in particular successive steps, specifically directly successive steps without intermediate steps.

As part of the invention, the term component is to preferably comprise individual parts. These individual parts can preferably not be split into smaller parts.

The components each have one, optionally also a plurality of contact surfaces. The contact surfaces are generally metallic, for example in the form of a metallization layer. The metal of the components or of the contact surfaces can be pure metal or an alloy of the metal. Aluminum, copper, silver, gold, nickel, palladium, iron and platinum are examples for the metal.

The contact surface of the components used in the method according to the invention can be in the range of, for example, between 1 and 150 mm².

The first and the second component to be connected thereto can be of the same type, i.e. they can for example be substrates in both cases, or they are each active or passive components or an active and a passive component. It is also possible, however, that the one component is a substrate and the other component is an active or passive component, or vice versa. The substrates, the active and the passive components are in particular parts, which are used in electronics.

The following embodiments can thus be differentiated, for example:

| First Component: | Second Component: |
|---|---|
| Substrate | substrate |
| active component | passive component |
| passive component | active component |
| active component | active component |
| passive component | passive component |
| Substrate | active component |
| Substrate | passive component |
| passive component | substrate |
| active components | substrate |

IMS substrates (insulated metal substrates), DCB substrates (direct copper bonded substrates), AMB substrates (active metal braze substrates), ceramic substrates, PCBs (printed circuit boards) and leadframes are examples for substrates.

Diodes, LEDs (light emitting diodes), dies (semiconductor chips), IGBTs (insulated-gate bipolar transistors), ICs (integrated circuits) and MOSFETs (metal-oxide-semiconductor field-effect transistors) are examples for active components.

Sensors, base plates, cooling elements, resistors, capacitors and coils are examples for passive components.

A metal paste containing an organic solvent is applied to the contact surface of a first component in step (1) of the method according to the invention.

The metal paste containing organic solvent is a common metal paste, which is known to the person of skill in the art as means for producing a sintering connection between components or the contact surfaces thereof, respectively, also referred to as metal sintering paste. Such metal pastes contain, for example, between 25 and 90% by weight of sinterable metal particles, in particular silver particles, silver alloy particles, copper particles and/or copper alloy particles; between 5 and 30% by weight of organic solvent; between 0 and 65% by weight of metal precursor compounds (metal precursors), in particular silver oxide, silver carbonate; between 0 and 5% by weight of sintering aids, for example peroxides, formiates; and between 0 and 5% by weight of other additives, for example saturated fatty acids and/or polymers, such as ethyl cellulose or polyimide.

Such metal pastes are disclosed in a variety of embodiments, for example in WO 2016/071005 A1, EP 3 009 211 A1, WO 2016/028221 A1, WO 2015/193014 A1, WO 2014/177645 A1, WO 2014/170050 A1, WO 2011/026624 A1, WO 2011/026623 A1, EP 2 572 814 A1, EP 2 425 920 A1, and EP 2 158 997 A2.

The application of the metal paste to the contact surface of the first component can be performed by means of conventional methods, for example by means of printing methods, such as screen printing, stencil printing or jetting. On the other hand, the application of the metal paste can also be performed by means of dispensing technology, by means of pin transfer or by means of dipping.

The method according to the invention comprises an optional step (2). If step (2) takes place, the metal paste as already mentioned above is also applied to the contact surface of the second component. The above-mentioned application methods are possible application methods.

The wet film thickness of the layer of the metal paste can preferably be in the range of between 20 and 200 μm. The wet film thickness can be dependent, for example, on the selected methods for applying the metal paste. In the case of the application of the metal paste by means of screen printing methods, the wet film thickness can be, for example, in the range of between 20 and 50 μm, in the case of stencil printing, for example in the range of between 50 and 200 μm, in the case of dispensing application for example in the range of between 20 and 100 μm, and in the case of application by means of jetting, for example in the range of between 20 and 70 μm.

The metal paste applied to the contact surface of the first and optionally also to the contact surface of the second component is dried in step (3) of the method according to the invention. In response to the drying, organic solvent is removed from the metal paste. According to a preferred embodiment, the portion of organic solvent in the dried metal paste is, for example, between 0 and 5% by weight or between 0 and <1% by weight, based on the original portion of organic solvent in the metal paste, i.e. application-ready metal paste. In other words, for example between 95 and 100% by weight or between >99 and 100% by weight of the organic solvent or solvents originally contained in the metal paste are removed in response to the drying according to this preferred embodiment.

It is significant for the invention that the drying is performed by irradiation with IR radiation with a peak wavelength in the wavelength range of between 750 and 1500 nm, preferably of between 750 and 1200 nm. If desired, a supporting oven drying, as common in the prior art, can simultaneously take place, but this is neither necessary nor preferred. In other words, it is not only possible but also preferred to effect the drying by means of the irradiation with IR radiation with a peak wavelength in the wavelength range of between 750 and 1500 nm, preferably of between 750 and 1200 nm, in particular solely by means of said irradiation.

Examples for usable radiation sources for such IR radiation comprise common NIR emitters (near-infrared emitters). Such NIR emitters can be obtained, for example, from Heraeus. The NIR emitters can be, for example, high-performance short wave emitters. The emitter or the individual NIR emitters can be operated with a power output of, for example, in the range of between 15 and 100 W/cm (Watt per centimeter emitter length), preferably in the range of between 20 and 50 W/cm. The emitter surface temperature (spiral-wound filament temperature) of the NIR emitters thereby lies, for example, in the range of between 1800 and 3000° C., preferably in the range of between 1850 and 2500° C. Suitable NIR emitters have, for example, an emission spectrum with a maximum in the range of between 750 and 1500 nm, preferably of between 750 and 1200 nm, in particular between 750 and 1500 nm or between 750 and 1200 nm.

The IR irradiation can be performed statically or in a pass-through plant, whereby the components, which are to be irradiated and which are provided with metal paste to be dried, and/or the IR radiation source or sources are moved relative to one another.

The distance between IR radiation source(s) or—more precisely—between radiation discharge surface of the IR radiation source or sources and the layer of the metal paste to be dried, lies, for example, in the range of between 1 and 50 cm, preferably between 5 and 20 cm.

The drying process effected by the IR irradiation requires a time period of, for example, in the range of only between 0.5 and 3 minutes and is thus significantly shorter than in the case of the above-mentioned oven drying according to the prior art. No quality disadvantages are created as compared to the sole oven drying. The person of skill in the art can thereby select the drying period in such a way that a sintering or pre-sintering of the drying or dried metal paste can be avoided.

Step (3) can be performed in an atmosphere, which is not subject to any particular limitations. The drying can thus be performed in an atmosphere, which contains oxygen, for example air. Even in the case of components comprising inherently oxidation-sensitive contact surface, such as, for example, a copper or nickel contact surface, operation can be performed in oxygenic atmosphere, for example with air, presumably as a result of the comparatively short drying period made possible as a result of the method according to the invention.

It goes without saying that it is also possible, if desired, to perform the drying in oxygen-free atmosphere. As part of the invention, an oxygen-free atmosphere is to be understood to be an atmosphere, the oxygen content of which is not more than 100 ppm vol. (ppm by volume), preferably not more than 10 ppm vol. and even more preferably not more than 1 ppm vol.

A sandwich arrangement of the two components with the dried metal paste in-between the two components is produced in step (4) of the method according to the invention. For this purpose, either the first component with its contact surface, which is provided with the dried metal paste, is attached to the contact surface of the second component, which is optionally also provided with the dried metal paste, or the second component is attached with its contact surface, which is optionally provided with the dried metal paste, to the contact surface of the first component, which is provided with the dried metal paste. As a result, dried metal paste or a layer of dried metal paste, respectively, is located between the components to be connected.

The sandwich arrangement comprising the layer of the dried metal paste is pressure-sintered in step (5) of the method according to the invention, for example at temperatures in the range of between 200 and 260° C., a pressing pressure of, for example in the range of between 3 and 30 MPa, and for a time period of, for example, in the range of between 1 and 5 minutes. The usual devices, which have already been mentioned above in the introduction describing the prior art with regard to the pressure sintering, can be used thereby.

As already specified with regard to step (3), step (5) can also take place in an atmosphere, which is not subject to any special limitations. Drying and pressure sintering can thus be performed in an atmosphere, which contains oxygen, for example air. It goes without saying that, if desired, it is also possible to perform the pressure sintering in oxygen-free atmosphere.

In summary, it should be noted that the method according to the invention for connecting components has advantages as compared to the prior art, namely a shortening of the drying period without loss of quality and the non-necessity of an inertization even in the case of working with components comprising oxidation-sensitive contact surface, for example copper or nickel contact surface.

### EXAMPLES AND COMPARATIVE EXAMPLES

1. Production of a metal paste: 85 parts by weight of silver particles (with 0.6% by weight of lauric acid/stearic acid in the weight ratio 25:75 of coated silver flakes), 7.4 parts by weight of α-terpineol, 7.4 parts by weight of iso-tridecanol and 0.2 parts by weight of ethyl cellulose were mixed to form a metal paste.

2. Application of the metal paste: The metal paste was applied over the entire surface of a DCB substrate in a wet film layer of 75 μm and comprising a surface of 4 mm-4 mm by means of stencil printing.

3a. Drying of the applied metal paste in an oven: The DCB substrate printed according to 2. was dried under nitrogen atmosphere at 130° C. oven temperature, except for a residual solvent content of the metal paste of <0.5% by weight, based on organic solvent originally contained in the metal paste (gravimetrically determined). The drying process required 15 minutes.

3b. Drying of the applied metal paste under IR irradiation: The DCB substrate printed according to 2., was irradiated with an NIR emitter of a length of 30 cm, a power output of 30 W/cm, a filament temperature of 2009° C., and with a peak wavelength of 1100 nm from above the metal paste in air from a distance of 10 cm, and was thus freed from the organic solvent except for a residual solvent content of <0.5% by weight, based on organic solvent originally contained in the metal paste (gravimetrically determined). The drying process effected solely by means of the IR irradiation required 1.5 minutes.

4a. or 4b., respectively Production of a sandwich arrangement: A silicon chip was attached to the metal paste dried according to 3a or 3b, respectively, at 130° C. with a silver contact surface of 4 mm-4 mm by forming a sandwich arrangement comprising a joint overlap surface of DCB substrate and chip of 4 mm-4 mm.

5. Pressure sintering of the sandwich arrangement produced according to 4a or 4b, respectively: The sandwich arrangement created in 4a or 4b., respectively, was pressure sintered for 2 minutes at 230° C. and a pressing pressure of 10 MPa under air atmosphere by using a heated sintering press.

After the cool-down, the adhesion was determined via the shear strength. The silicon chips were thereby sheared by means of a shearing chisel at a speed of 0.3 mm/s at 260° C. The force was recorded by means of a measuring box (device DAGE 2000 by DAGE, Germany). Shear strengths of above 20 N/mm² represent satisfactory results.

Measured shear strength 5a: 62 N/mm²

Measured shear strength 5b: 64 N/mm²

1. A method for connecting components, comprising the following steps:
(1) applying a metal paste containing an organic solvent to the contact surface of a first component,
(2) optionally applying the metal paste to the contact surface of a second component to be connected to the first component,
(3) drying the metal paste applied to the contact surface of the first component and optionally also to the contact surface of the second component,
(4) producing a sandwich arrangement with the first and second components and the dried metal paste in-between, and
(5) pressure sintering the sandwich arrangement comprising the layer of dried metal paste,
wherein the drying is performed by irradiation with infrared (IR) radiation with a peak wavelength in the wavelength range of between 750 and 1500 nm.

2. The method of claim 1, wherein the contact surfaces of the first and second components lies in the range of between 1 and 150 mm².

3. The method claim 1, wherein the first and second components are selected from the group consisting of substrates, active components and passive components.

4. The method of claim 1, wherein the metal paste applied in step (1) and optionally in step (2) contains between 25 and 90% by weight of sinterable metal particles, between 5 and 30% by weight of the organic solvent, between 0 and 65% by weight of metal precursor compounds, between 0 and 5% by weight of sintering aids, and between 0 and 5% by weight of other additives.

5. The method of claim 1, wherein between 95 and 100% by weight of the organic solvent originally contained in the metal paste are removed during step (3).

6. The method of claim 1, wherein the peak wavelength lies in the wavelength range of between 750 and 1200 nm.

7. The method of claim 1, wherein the drying is effected solely by means of the irradiation with IR radiation.

8. The method of claim 1, wherein one or a plurality of near-infrared (NIR) emitters, which are operated with a power output in the range of between 15 and 100 W/cm, are used as radiation sources for the IR radiation.

9. The method of claim 8, wherein the emitter surface temperature of the one or plurality of NIR emitters lies in the range of between 1800 and 3000° C.

10. The method of claim 1, wherein the distance between a radiation discharge surface of an IR radiation source or sources and the layer of the metal paste to be dried lies in the range of between 1 and 50 cm.

11. The method of claim 1, wherein the drying according to step (3) takes between 0.5 and 3 minutes.

12. The method of claim 1, wherein step (3) and/or step (5) are performed in an oxygenic or in an oxygen-free atmosphere, wherein, in both cases, one or both of the first and second components have an oxidation-sensitive contact surface.
